(19) United States
(12) Patent Application Publication
(10) Pub. No.: US 2026/0008282 A1
(43) Pub. Date: Jan. 8, 2026

(54) CONVEYANCE GUIDE MEMBER AND DRYING APPARATUS

(71) Applicant: KYOCERA Document Solutions Inc., Osaka (JP)

(72) Inventor: Takashi KOTANI, Osaka (JP)

(73) Assignee: KYOCERA Document Solutions Inc., Osaka (JP)

(21) Appl. No.: 19/247,859

(22) Filed: Jun. 24, 2025

(30) Foreign Application Priority Data
Jul. 3, 2024 (JP) 2024-107119

(51) Int. Cl. B41J 13/10; B41J 11/00

(52) U.S. Cl. CPC B41J 13/106; B41J 11/0024

(57) ABSTRACT

A conveyance guide member includes a main body portion, a downstream end portion, and a slit. The main body portion has a plate-like shape, and defines a conveyance path along which a sheet is conveyed in a predetermined conveyance direction. The downstream end portion is provided at an end portion of the main body portion on a downstream side in the conveyance direction and bent away from the conveyance path. The slit is provided along the conveyance direction over the main body portion and the downstream end portion. A width of the slit at the downstream end portion is wider than a width of the slit at the main body portion.

### INCORPORATION BY REFERENCE

This application is based on and claims the benefit of priority from Japanese patent application No. 2024-107119 July 3, 2024, which is incorporated by reference in its entirety.

### TECHNICAL FIELD

The present disclosure relates to a conveyance guide member and a drying apparatus.

### BACKGROUND

When an image is formed on a sheet by an inkjet system, it is necessary to quickly dry the ink ejected on the sheet in order to prevent image irregularity, deformation and sticking of the sheet, and the like. As an example of a technique for drying the ink, a drying apparatus including a conveyance belt for conveying the sheet and a heat source for supplying heat to the ink on the sheet is known. In this configuration, since the sheet after drying is heated to a high temperature, it is desirable to provide a means for accelerating cooling of the sheet downstream of the conveyance belt in the conveyance direction. In particular, in the case of large size or thick sheets, since much heat is stored in the sheet after drying by the drying apparatus, it is necessary to cool it quickly. However, since the conveyance path downstream of the conveyance belt in the conveyance direction is made of plate-like conveyance guide members facing both sides of the sheet, hot air tends to accumulate and the sheet is hardly cooled. Therefore, it is considered to improve the air permeability by providing an opening in the conveyance guide member. As an example of the opening, for example, there is a slit along the conveyance direction.

However, the lateral end of the sheet (the end in the width direction crossing the conveyance direction) may curl, and in this case, the lateral end of the sheet may enter the slit, and the front end of the sheet (the end in front of the conveyance direction) may be in contact with the downstream end of the slit in the conveyance direction. In this case, the sheet may be damaged or clogged.

### SUMMARY

A conveyance guide member according to the present disclosure includes a main body portion, a downstream end portion, and a slit. The main body portion has a plate-like shape, and defines a conveyance path along which a sheet is conveyed in a predetermined conveyance direction. The downstream end portion is provided at an end portion of the main body portion on a downstream side in the conveyance direction and bent away from the conveyance path. The slit is provided along the conveyance direction over the main body portion and the downstream end portion. A width of the slit at the downstream end portion is wider than a width of the slit at the main body portion.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a front view schematically showing an internal structure of an image forming system according to one embodiment of the present disclosure.

FIG. 2 is a front view showing a conveyance guide member according to the embodiment of the present disclosure.

FIG. 3 is a bottom view showing an upper conveyance guide member according to the embodiment of the present disclosure.

FIG. 4 is a perspective view showing a body portion and a downstream end portion of the conveyance guide member according to the embodiment of the present disclosure.

FIG. 5 is a perspective view showing a parallel portion and a downstream end portion of a conventional conveyance guide member.

FIG. 6 is a left side view showing the downstream end portion of the conventional conveyance guide member.

FIG. 7 is a left side view showing the downstream end portion of the conventional conveyance guide member.

FIG. 8 is a left side view showing the downstream end portion of the conveyance guide member according to the embodiment of the present disclosure.

FIG. 9 is a front view schematically showing a branch point between conveyance paths.

FIG. 10 is a perspective view schematically showing the conventional conveyance guide member.

FIG. 11 is a perspective view schematically showing the conveyance guide member of the present embodiment.

### DETAILED DESCRIPTION

Hereinafter, with reference to the drawings, an image forming system 100 according to one embodiment of the present disclosure will be described.

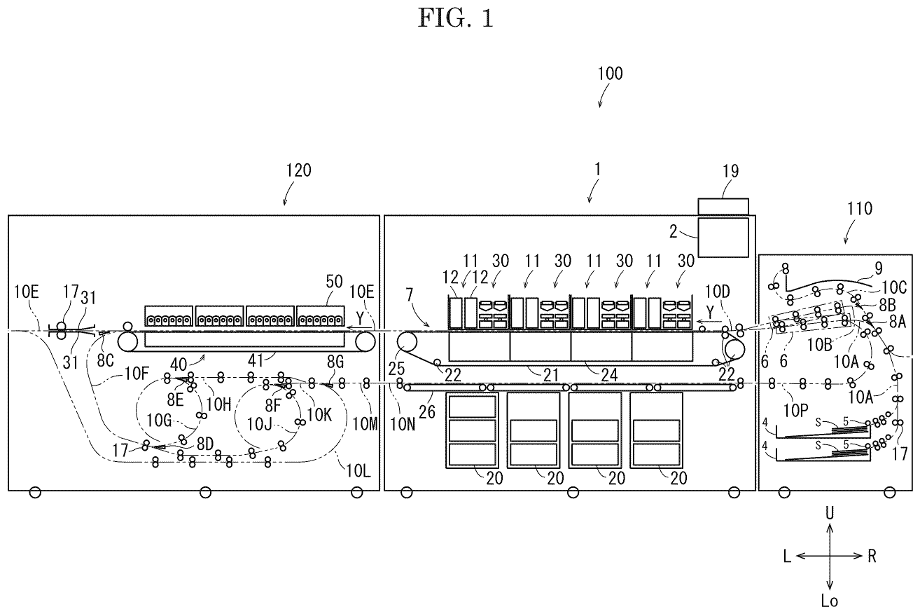

FIG. 1 is a front view schematically showing an internal structure of the image forming system 100. Hereinafter, the front side of the paper plan on which FIG. 1 is drawn is defined as the front side of the image forming system 100, and the left-and-right direction will be described with reference to the direction in which the image forming system 100 is shown from the front side. In each figure, U, Lo, L, R, Fr, and Rr indicate the upper, lower, left, right, front, and rear, respectively.

The image forming system 100 includes a sheet feeding apparatus 110, an inkjet recording apparatus 1, and a drying apparatus 120. The sheet feeding apparatus 110 stores a sheet S, and feeds the sheet S to the inkjet recording apparatus 1. The inkjet recording apparatus 1 forms an image on the sheet S by an inkjet system. The drying apparatus 120 heats the sheet S conveyed from the inkjet recording apparatus 1 to dry the ink. A post-processing apparatus (not shown) for loading the discharged sheet S may be provided on the left side of the drying apparatus 120. The post-processing apparatus may have functions, such as staple closing, folding, and drilling.

The sheet feeding apparatus 110 includes a sheet feeding cassette 4, a sheet feeding roller 5, a conveyance path 10A, a sheet aligning device 6, and a retreat tray 9. The sheet feeding cassette 4 stores the stacked sheets S. The sheet feeding roller 5 feeds the sheets S one by one from the sheet feeding cassette 4 to the conveyance path 10A. Two of the sheet aligning devices 6 having the same basic configuration are arranged above and below. The sheet aligning device 6 has a function of correcting the skew of the sheet S with respect to the conveyance direction A and a function of correcting the displacement of the position of the sheet S in the width direction X crossing the conveyance direction A. The conveyance path 10A communicates with the lower sheet aligning device 6. A conveyance path 10B is branched from the conveyance path 10A and communicates with the upper sheet aligning device 6. A conveyance path 10C is branched from the conveyance path 10B and communicates with the retreat tray 9. On the conveyance paths 10A, 10B and 10C, conveyance rollers 17 for conveying the sheet S are provided.

An opening/closing member 8A is provided at a branch point between the conveyance path 10A and the conveyance path 10B, which is turned around an axis to open one of the conveyance path 10A and the conveyance path 10B and to close the other. The sheet S is guided to the conveyance path 10A by opening the conveyance path 10A by the opening/closing member 8A, and the sheet S is guided to the conveyance path 10B by opening the conveyance path 10B by the opening/closing member 8B.

An opening/closing member 8B is provided at a branch point between the conveyance path 10B and the conveyance path 10C, which is turned around an axis to open one of the conveyance path 10B and the conveyance path 10C and to close the other. The sheet S is guided to the conveyance path 10B by opening the conveyance path 10B by the opening/closing member 8B, and the sheet S is guided to the conveyance path 10C by opening the conveyance path 10C by the opening/closing member 8B.

The inkjet recording apparatus 1 includes a conveying unit 7 which attracts and conveys the sheet S in the predetermined conveyance direction Y. Four head units 11 which ejects the ink to form an image are provided above the conveying unit 7. The inkjet recording apparatus 1 includes a conveyance path 10D passing through a gap between the conveying unit 7 and the head units 11. The conveyance path 10A and the conveyance path 10B are merged with the conveyance path 10D.

The conveying unit 7 includes an endless conveying belt 21 and a suction part 24. The conveying belt 21 has a large number of air-holes (not shown), and is wound around a driving roller 25 and a driven roller 22. The upper surface of the suction part 24 has a large number of air-holes (not shown), and is in contact with the inner surface of the conveying belt 21. The suction part 24 sucks air through the air-holes of the conveying belt 21 and the air-hole of the suction part 24, thereby attracting the sheet S to the conveying belt 21. The driving roller 25 is driven in the counterclockwise direction by a drive unit (not shown) including a motor and a reduction gear, whereby the conveying belt 21 travels in the counterclockwise direction, and the sheet S attracted to the conveying belt 21 is conveyed in the Y direction.

Each head unit 11 includes one or more inkjet heads 12. Ink containers 20 filled with the black, cyan, magenta and yellow inks are connected to the respective head units 11. The four head units 11 are arranged at intervals from each other, and a maintenance unit 30 for performing maintenance of the inkjet head 12 is arranged on the right side of each head unit 11.

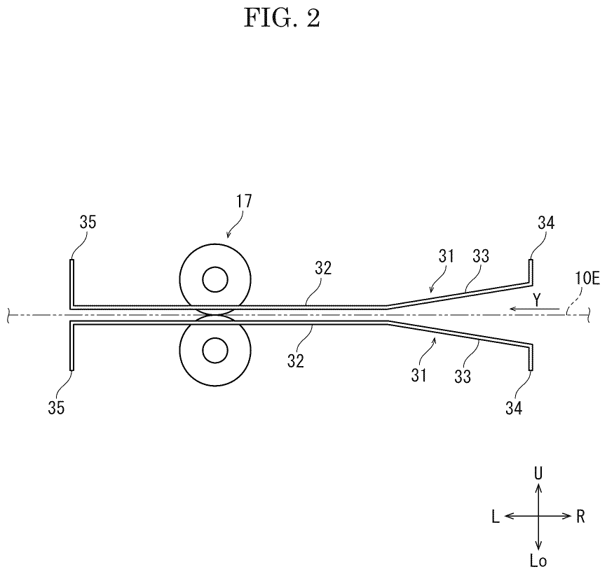

The control part 2 (see FIG. 2) includes an arithmetic part and a storage part (not shown). The arithmetic part is, for example, a CPU (Central Processing Unit). The storage part includes a storage medium such as ROM (Read Only Memory), RAM (Random Access Memory), and EEPROM (Electrically Erasable Programmable Read Only Memory). The arithmetic part reads and executes the control program stored in the storage part to perform various processes. The control part 2 may be implemented by an integrated circuit that does not use software.

A display operation part 19 includes a display panel, a touch panel laminated on the display panel, and a keypad (not shown). The control part 2 displays a screen showing an operation menu, a status or the like of the inkjet recording apparatus 1 on the display panel, and controls each part of the inkjet recording apparatus 1 according to the operation detected by the touch panel and the keypad.

The drying apparatus 120 includes a conveying unit 40 and a heating unit 50. The conveying unit 90 attracts the sheet S to the conveyance belt 41 by the same principle as that of the conveying unit 7, and conveys the sheet S in the Y direction. The heating unit 50 is provided with a heat source such as an infrared heater to dry the ink on the sheet S.

The drying apparatus 120 includes a conveyance path 10E passing through a gap between the conveying unit 40 and the heating unit 50. The conveyance path 10D is connected to the conveyance path 10E. A conveyance path 10F is branched downward from the conveyance path 10E. The conveyance path 10F is branched into a conveyance path 10G and a conveyance path 10J. The conveyance path 10G and the conveyance path 10J are curved in an arc shape. A conveyance path 10H is branched rightward from the conveyance path 10G, and a conveyance path 10K is branched rightward from the conveyance path 10J. The conveyance path 10H and the conveyance path 10K are merged with a conveyance path 10M. A conveyance path 10L is branched downward from the conveyance path 10M, passes below the conveyance paths 10J, 10G, and 10F, and is merged with the conveyance path 10E. On the conveyance paths 10E, 10F, 10G, 10H, 10J, 10K, 10L and 10M, conveyance rollers 17 for conveying the sheet S are provided.

An opening/closing member 8C is provided at a branch point between the conveyance path 10E and the conveyance path 10F, which is turned around an axis to open one of the conveyance path 10E and the conveyance path 10F and to close the other. The sheet S is guided to the conveyance path 10E by opening the conveyance path 10E by the opening/closing member 8C, and the sheet S is guided to the conveyance path 10F by opening the conveyance path 10F by the opening/closing member 8C.

An opening/closing member 8D is provided at a branch point between the conveyance path 10G and the conveyance path 10K, which is turned around an axis to open one of the conveyance path 10G and the conveyance path 10K and to close the other. The sheet S is guided to the conveyance path 10G by opening the conveyance path 10G by the opening/closing member 8D, and the sheet S is guided to the conveyance path 10K by opening the conveyance path 10K by the opening/closing member 8C.

An opening/closing member 8E is provided at a branch point between the conveyance path 10G and the conveyance path 10H, which is turned around an axis to open one of the conveyance path 10G and the conveyance path 10H and to close the other. When the sheet S is inverted, the opening/closing member 8E opens the conveyance path 10G, and the conveyance roller 17 conveys the sheet S in the counterclockwise direction until the trailing end of the sheet S entering the conveyance path 10G exceeds the branch point, and then the opening/closing member 8E opens the conveyance path 10H, and the conveyance roller 17 conveys the sheet S in the clockwise direction.

An opening/closing member 8F is provided at a branch point between the conveyance path 10J and the conveyance path 10K, which is turned around an axis to open one of the conveyance path 10J and the conveyance path 10K and to close the other. When the sheet S is inverted, the opening/closing member 8F opens the conveyance path 10J, and the conveyance roller 17 conveys the sheet S in the counterclockwise direction until the trailing end of the sheet S entering the conveyance path 10J exceeds the branch point, and then the opening/closing member 8F opens the conveyance path 10K, and the conveyance roller 17 conveys the sheet S in the clockwise direction.

An opening/closing member 8G is provided at a branch point between the conveyance path 10L and the conveyance path 10M, which is turned around an axis to open one of the conveyance path 10L and the conveyance path 10M and to close the other. The sheet S is guided to the conveyance path 10L by opening the conveyance path 10L by the opening/closing member 8G, and the sheet S is guided to the conveyance path 10M by opening the conveyance path 10M by the opening/closing member 8G.

The inkjet recording apparatus 1 includes a conveyance path 10N connected to the conveyance path 10M, and the sheet feeding includes apparatus 110 a conveyance path 10P extending from the conveyance path 10N to the lower sheet aligning device 6. The conveyance path 10N includes, for example, an electrostatic attraction type conveying belt 26 for attracting and conveying the sheet S by static electricity.

The basic operation of the image forming system 100 is as follows. When an image forming job is input to the inkjet recording apparatus 1 from the display operation part 19 or an external computer, the sheet feeding roller 5 feeds the sheet S one by one from the sheet feeding cassette 4 to the conveyance path 10A. Each time the sheet S is fed out, the opening/closing member 8A alternately opens the conveyance path 10A and the conveyance path 10B, and the lower and upper sheet aligning devices 6 alternately perform sheet aligning processing. When the sheet aligning device 6 feeds the sheet S to the conveying unit 7 at a predetermined timing, the conveying unit 7 attracts the sheet S to the conveying belt 21, and conveys the sheet S in the Y direction. When the control part 2 supplies raster type image data to the head units 11 in synchronization with the conveyance of the sheet S, the ink is ejected from the head unit 11 to form an image on the sheet S. The sheet S on which the image is formed is conveyed to the drying apparatus 120.

In the drying apparatus 120, the ink on the sheet S conveyed along the conveyance path 10E is dried. In the case of an image forming job for one-sided printing of only one sheet, the sheet S is guided to the conveyance path 10E and then conveyed to the post-processing apparatus (not shown) connected to the left side of the drying apparatus 120. On the other hand, in the case of the image forming job for one-sided printing of a plurality of the sheets, the sheet S is guided to the conveyance path 10F, and after being inverted by alternately using the conveyance path 10G and the conveyance path 10J, the sheet S is conveyed to the post-processing apparatus via the conveyance path 10L.

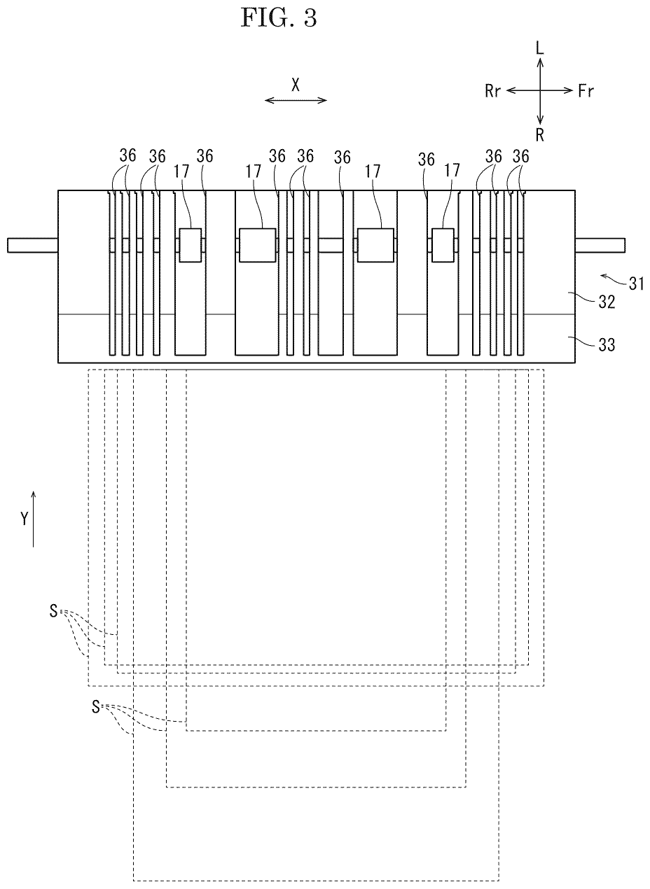

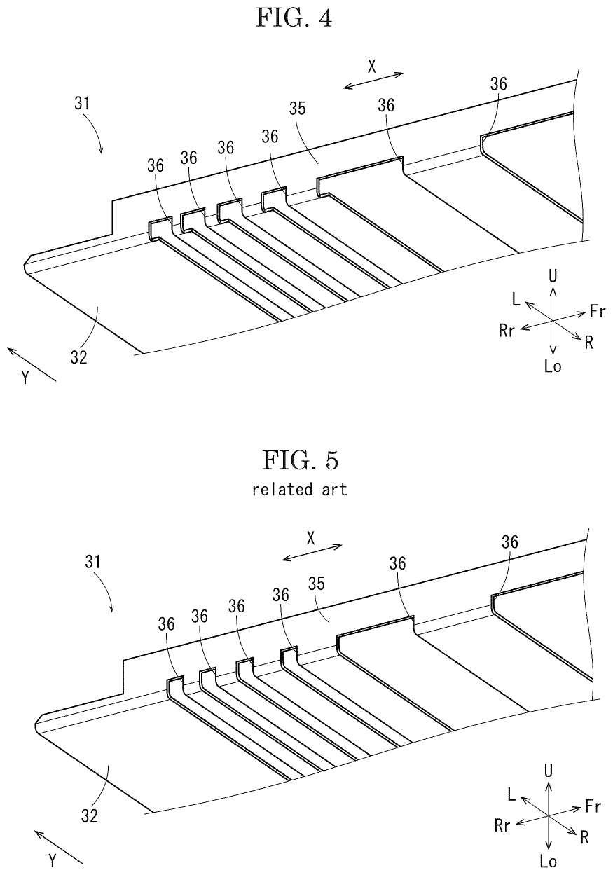

On the other hand, in the case of the image forming job of double-sided printing, the sheet S is inverted by alternately using the conveyance path 10G and the conveyance path 10J, and then conveyed to the lower sheet aligning device 6 via the conveyance paths 10M, 10N, and 10P, and an image is formed on the rear surface by the inkjet recording apparatus 1. After that, the ink is dried by the drying apparatus 120, and after being inverted by alternately using the conveyance path 10G and the conveyance path 10J, the sheet is conveyed to the post-processing apparatus via the conveyance path 10L.

[Conveyance Guide Member] FIG. 2 is a front view showing a conveyance guide member 31. FIG. 3 is a bottom view showing the upper conveyance guide member 31. FIG. 4 is a perspective view showing a main body portion 32 and a downstream end portion 35 of the conveyance guide member 31. FIG. 8 is a left side view showing the downstream end portion 35 of the conveyance guide member 31. Hereinafter, the upstream side in the conveyance direction Y and the downstream side in the conveyance direction are referred to as the upstream side and the downstream side, respectively.

The conveyance guide member 31 is provided, for example, in the conveyance path 10E (see FIG. 1). The upper and lower boundaries of the conveyance path 10E are defined by a pair of the conveyance guide members 31 facing up and down. Although the upper conveyance guide member 31 will be described below, the lower conveyance guide member 31 has the same configuration as the upper conveyance guide member except that its basic shape is inverted in the upper-and-lower direction.

The entire conveyance guide member 31 has a plate shape. Although the conveyance guide member 31 may be made of metal, resin, or the like, metal is preferable from the viewpoint of thermal conductivity. In the case of metal, aluminum is excellent in workability but has low rigidity and is expensive, so stainless steel, which has high rigidity and is inexpensive, is desirable.

The conveyance guide member 31 (see FIG. 2) has a main body portion 32, an inclined portion 33, an upstream end portion 34, and a downstream end portion 35. The main body portion 32 is arranged in parallel with the main body portion 32 of the paired lower conveyance guide members 31. The inclined portion 33 is provided on the upstream side of the main body portion 32 and inclined so as to be separated from the conveyance path 10E as it extends upstream. The upstream end portion 34 is provided at the upstream end portion of the inclined portion 33 and is bent toward a side separated from the conveyance path 10E. The downstream end portion 35 is provided at the downstream end portion of the main body portion 32 and is bent toward the side separated from the conveyance path 10E.

The conveyance guide member 31 has slits 36 (see FIG. 3, FIG. 4 and FIG. 8) along the conveyance direction Y. The slit 36 is provided at a plurality of positions in the width direction X intersecting the conveyance direction Y. The slits 36 are provided at a position different from the ends of the sheet S in the width direction X intersecting the conveyance direction Y. In the image forming system 100, a plurality of kinds of the sheets S (see FIG. 3, for example, A4, A3, B4, B5, Legal, and Letter) having different sizes can be used. Therefore, the slits 36 are provided between the ends in the width direction X of the plurality of kinds of sheets S having different sizes.

The slit 36 is provided over the main body portion 32 and the downstream end portion 35. Specifically, the slit 36 reaches the downstream end portion 35 at a predetermined height lower than the upper end of the downstream end portion 35 through the main body portion 32 from the inclined portion 33. A width W2 of the slit 36 at the downstream end portion 35 is wider than a width W1 of the slit 36 at the main body portion 32. The slit 36 at the downstream end portion 35 is widened in a direction away from the center of the conveyance path 10E.

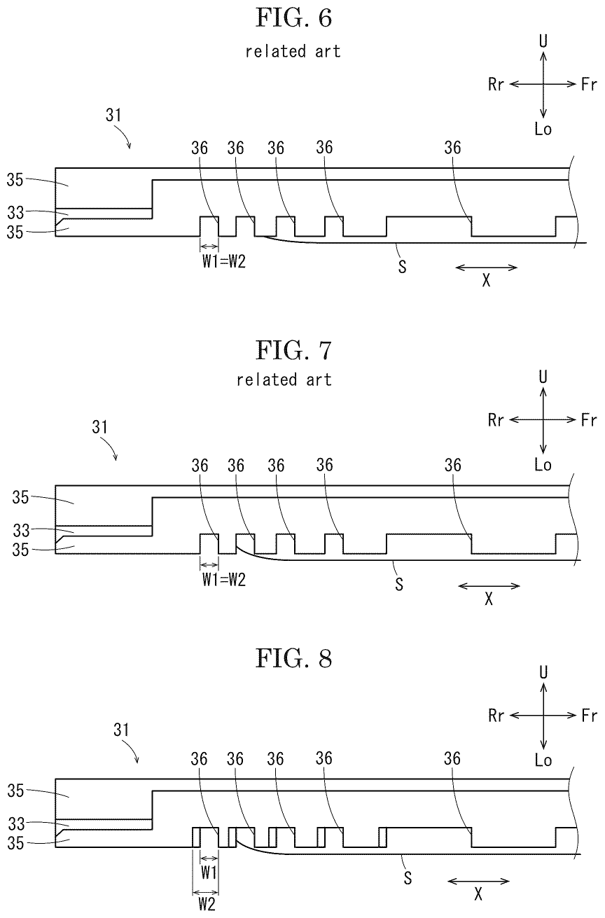

FIG. 5 is a perspective view showing the main body portion 32 and the downstream end portion 35 of the conventional conveyance guide member 31. FIG. 6 and FIG. 7 are left side views showing the downstream end portion 35 of the conventional conveyance guide member 31. In the conventional conveyance guide member 31, the width W2 of the slit 36 at the downstream end portion 35 is the same as the width W1 of the slit 36 at the main body portion 32 (see FIG. 6). In the case where the end portion of the sheet S in the width direction X is curled upward, if the end portion of the sheet S in the width direction X is positioned between the slits 36, the sheet S is conveyed without problems. However, in the case where the position of the sheet S in the width direction X is shifted or the sheet S is slightly larger than normal, the end portion of the sheet S in the width direction X enters the slit 36, and the front end portion in the conveyance direction Y of the end portion of the sheet S in the width direction X may be into contact with the downstream end portion 35.

On the other hand, in the present embodiment (see FIG. 8), the width W2 of the slit 36 at the downstream end portion 35 is wider than the width W1 of the slit 36 at the main body portion 32. The slit 36 at the downstream end portion 35 is widened in a direction away from the center of the conveyance path 10E. With this configuration, it is possible to prevent the front end portion of the sheet S from coming into contact with the downstream end portion in the conveyance direction Y of the slit 36 provided in the conveyance guide member 31.

The conveyance guide member 31 according to the present embodiment described above includes the plate-like main body portion 32 defining the conveyance path 10E along which the sheet S is conveyed in the predetermined conveyance direction Y, the downstream end portion 35 provided at the downstream end portion of the main body portion 32 in the conveyance direction Y and bent away from the conveyance path 10E, and the slits 36 provided along the conveyance direction Y over the main body portion 32 and the downstream end portion 35, wherein the width W2 of the slit 36 at the downstream end portion 35 is wider than the width W1 of the slit 36 at the main body portion 32. According to the present embodiment, it is possible to prevent the front end portion of the sheet S from coming into contact with the downstream end portion of the slit 36 in the conveyance direction Y provided in the conveyance guide member 31.

According to the conveyance guide member 31 according to the present embodiment, the slit 36 at the downstream end portion 35 is widened in a direction away from the center of the conveyance path 10E. According to the present embodiment, it is possible to prevent the front end portion of the sheet S from coming into contact with the downstream end portion of the slit 36 in the conveyance direction Y provided in the conveyance guide member 31.

According to the conveyance guide member 31 according to the present embodiment, the slit 36 is provided at a position different from the end portions of the sheet S in the width direction X intersecting the conveyance direction Y. According to the present embodiment, the end portions of the sheet S in the width direction X can hardly enter the slits 36.

According to the conveyance guide member 31 according to the present embodiment, the slits 36 are provided between the end portions of the plurality of kinds of sheets S having different sizes. According to the present embodiment, even when the plurality of kinds of sheets S of different sizes are used, it is possible to prevent the front end portion of the sheet S from coming into contact with the downstream end portion of the slit 36 in the conveyance direction Y.

Further, the drying apparatus 120 according to the present embodiment includes the heat source (heating unit 50) for heating the sheet S conveyed along the conveyance path 10E, and the conveyance guide member 31 provided downstream of the heat source in the conveyance direction Y. According to the present embodiment, cooling of the sheet S after heating can be promoted.

The above embodiment may be modified as follows.

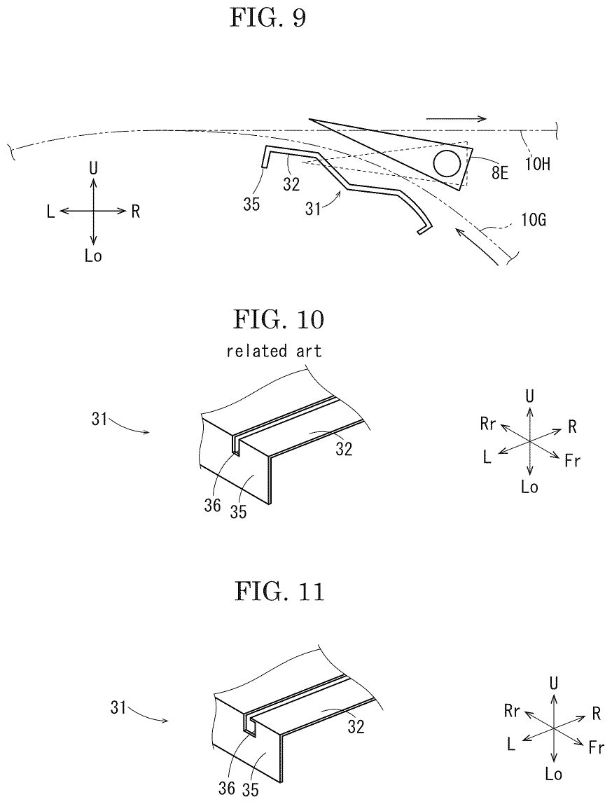

FIG. 9 is a front view schematically showing a branch point between the conveyance path 10G and the conveyance path 10H. FIG. 10 is a perspective view schematically showing the conventional conveyance guide member 31. FIG. 11 is a perspective view schematically showing the conveyance guide member 31 of this embodiment.

The conveyance guide member 31 is provided at the branch point between the conveyance path 10G and the conveyance path 10H. The conveyance guide member 31 is provided with a slit 36 (see FIG. 10 and FIG. 11) for accommodating the front portion of the end opening/closing member 8E from the main body portion 32 to the downstream end portion 35 in order to prevent the sheet S to be switched back from entering between the opening/closing member 8E and the conveyance guide member 31. When the sheet S enters the conveyance path 10G, the opening/closing member 8E opens the conveyance path 10G by lifting its front end as shown by the solid line in FIG. 9. On the other hand, when the sheet S is switched back from the conveyance path 10G to the conveyance path 10H, the opening/closing member 8E opens the conveyance path 10H by accommodating the front end portion in the slit 36 as shown by the broken line in FIG. 9.

When the sheet S enters along the conveyance path 10G, in the conventional conveyance guide member 31, if the end portions of the sheet S in the width direction X are curled, the sheet S may come into contact with the downstream end portion 35. On the other hand, in the present modified example, since the slit 36 is widened at the downstream end portion 35, the sheet S hardly comes into contact with the downstream end portion 35.

1. A conveyance guide member comprising:
a plate-like main body portion which defines a conveyance path along which a sheet is conveyed in a predetermined conveyance direction;
a downstream end portion provided at an end portion of the main body portion on a downstream side in the conveyance direction and bent away from the conveyance path; and
a slit provided along the conveyance direction over the main body portion and the downstream end portion, wherein
a width of the slit at the downstream end portion is wider than a width of the slit at the main body portion.

2. The conveyance guide member according to claim 1, wherein
the slit at the downstream end portion is widened in a direction away from a center of the conveyance path.

3. The conveyance guide member according to claim 1, wherein
the slit is provided at a position different from an end portion of the sheet in a width direction crossing the conveyance direction.

4. The conveyance guide member according to claim 3, wherein
the slit is provided between the end portions of a plurality of kinds of the sheets having different sizes.

5. A drying apparatus comprising:
a heat source which heats the sheet conveyed along the conveyance path, and
the conveyance guide member according to claim 1, which is provided on the downstream side of the heat source in the conveyance direction.
